(19) United States
(12) Patent Application Publication
(10) Pub. No.: US 2026/0228732 A1
(43) Pub. Date: Aug. 6, 2026

(54) BIOMETRIC ENHANCED TRANSACTION VERIFICATION

(71) Applicant: MASTERCARD INTERNATIONAL INCORPORATED, Purchase, NY (US)

(72) Inventors: Shubham Mondal, Bardhaman (IN); Ajay Sinha, Pune (IN); Naveen Kumar Gupta, Pune (IN)

(21) Appl. No.: 19/043,958

(22) Filed: Feb. 3, 2025

(51) Int. Cl. G06Q 20/40; H04L 9/08

(52) U.S. Cl. CPC G06Q 20/40145; H04L 9/0866

(57) ABSTRACT

Systems and techniques for encrypting a cryptogram using a biometric cryptographic key to create a biometric encrypted cryptogram are described. In some aspects, the techniques described herein relate to a payment device, including: a processing system; a communications interface; one or more storage media; and instructions stored on the one or more storage media that, when executed by the processing system, direct the processing system to at least: receive an indicator to initiate payment for a transaction; in response to receiving the indicator, generate a cryptogram for the transaction; receive biometric data of a user; generate a biometric cryptographic key using the biometric data; encrypt the cryptogram using the biometric cryptographic key to generate a biometric encrypted cryptogram; and provide the biometric encrypted cryptogram to a point-of-sale (POS) system for authorization of the transaction.

### BACKGROUND

During a payment transaction process flow (e.g., debit or credit), cardholder verification (e.g., PIN verification) can be an important process to protect against fraudulent use of a payment card. However, increasingly, cardholder verification is not required or utilized during the transaction flow.

Thus, in cases where no conventional cardholder verification (e.g., PIN) is required, an imposter in possession of a payment card (or associated payment card number and information) can successfully complete transactions using the payment card. Even when conventional cardholder verification is required, if the imposter also possesses the PIN information, then the fraudulent transactions can also occur

### BRIEF SUMMARY

Systems and techniques for providing biometric enhanced transaction verification are provided. By encrypting a cryptogram using a biometric cryptographic key to create a biometric encrypted cryptogram, improved security is possible.

As described herein, the standard cryptogram used as part of a conventional transaction flow can be encrypted using a biometric cryptographic key that is generated using biometric data of a user received during the transaction. When the biometric encrypted cryptogram is received for verification by an issuer, only a biometric cryptographic key generated using biometric data of the same user is able to decrypt the biometric encrypted cryptogram to verify the transaction. Advantageously, the use of the biometric encrypted cryptogram increases payment data security and reduces chances for fraudulent charges to occur.

In some aspects, the techniques described herein relate to a payment device, including: a processing system; a communications interface; one or more storage media; and instructions stored on the one or more storage media that, when executed by the processing system, direct the payment device to at least: receive an indicator to initiate payment for a transaction; in response to receiving the indicator, generate a cryptogram for the transaction; receive biometric data of a user; generate a biometric cryptographic key using the biometric data; encrypt the cryptogram using the biometric cryptographic key to generate a biometric encrypted cryptogram; and provide the biometric encrypted cryptogram to a point-of-sale (POS) system for authorization of the transaction.

In some aspects, the techniques described herein relate to a method that can be carried out by an issuer computing system, including: receiving an authorization request for a transaction, wherein the authorization request includes a biometric encrypted cryptogram; obtaining a biometric cryptographic key generated using biometric data of a user; decrypting the biometric encrypted cryptogram using the biometric cryptographic key to extract a cryptogram; verifying the cryptogram; and sending an authorization signal for the transaction in response to verifying the cryptogram.

In some aspects, obtaining the biometric cryptographic key can include generating the biometric cryptographic key, where generating the biometric cryptographic key can include: extracting features from stored biometric data of the user; converting the extracted features into a binary string; converting the binary string into a gray code sequence; applying error correction to the gray code sequence using the redundant data to generate a key; and applying a hashing function to the key to create the biometric cryptographic key.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example conventional payment card process flow.

FIG. 2 illustrates an operating environment and example biometric encrypted cryptogram transaction process flow using a payment device.

FIG. 3 illustrates an example process for generating a biometric encrypted cryptogram.

FIG. 4 illustrates an example method for generating a biometric cryptographic key at a payment device.

FIG. 5 illustrates an example process for decrypting a biometric encrypted cryptogram at an issuer.

FIG. 6 illustrates a method for generating a biometric cryptographic key at an issuer.

FIG. 7A-7B illustrates an example use case of a biometric encrypted cryptogram transaction process flow.

FIG. 8A illustrates components of a payment device that may be used in certain embodiments described herein.

FIG. 8B illustrates components of a computing system that may be used in certain embodiments described herein.

### DETAILED DESCRIPTION

Systems and techniques for providing biometric enhanced transaction verification are provided. By encrypting a cryptogram using a biometric cryptographic key to create a biometric encrypted cryptogram, improved security is possible.

As described herein, the standard cryptogram used as part of a conventional transaction flow can be encrypted using a biometric cryptographic key that is generated using biometric data of a user received during the transaction. When the biometric encrypted cryptogram is received for verification by an issuer, only a biometric cryptographic key generated using biometric data of the same user is able to decrypt the biometric encrypted cryptogram to verify the transaction. Advantageously, the use of the biometric encrypted cryptogram increases payment data security and reduces chances for fraudulent charges to occur.

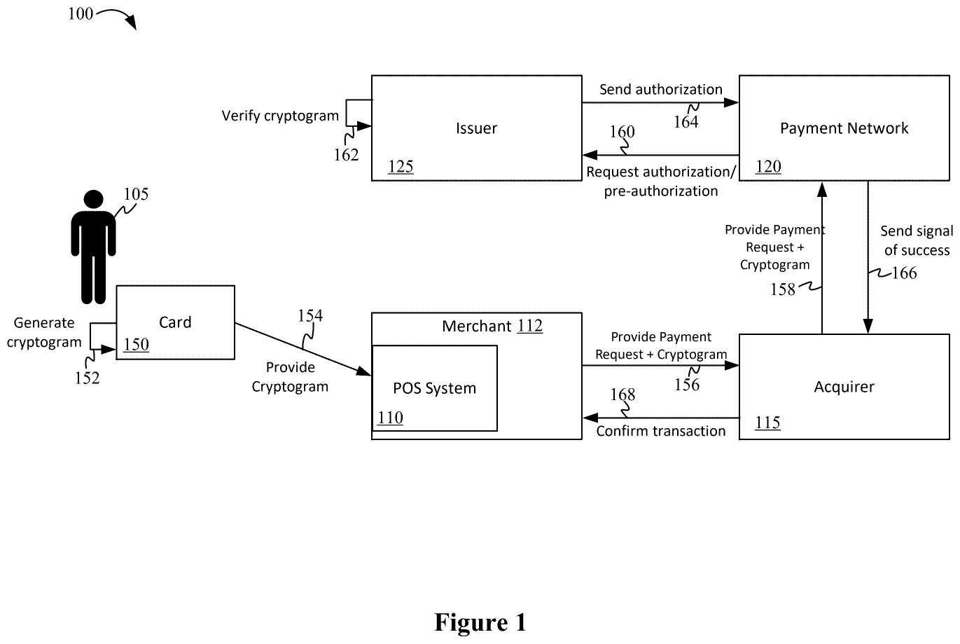

FIG. 1 illustrates an example conventional payment card process flow. Referring to FIG. 1, in conventional payment card processes, there can be communication between a user 105, a merchant 112, an acquirer 115, a payment network 120, and an issuer 125. These communications can include a payment process using a payment card 150. The payment process can include payment card authorization, clearing, and settlement.

The user 105 can be the cardholder or a person authorized to use the account on behalf of the cardholder. The merchant 112 can be a provider of goods or services in exchange for payment. The POS system 110 can be associated with the merchant 112. The POS system 110 can include hardware and software to facilitate the processing of payments and completion of purchases. In some cases, the POS system 110 can be physically present at a sale (e.g., as a point-of-sale terminal) or remote, such as at an online retailer. The acquirer 115 can be a party that receives funds on behalf of the merchant 112 in a payment card transaction. The acquirer 115 can be a bank or other institution associated with the merchant 112. The payment network 120 facilitates transactions between merchants (e.g., merchant 112) and payment card issuers (e.g., issuer 125). Examples of payment network 120 include the Mastercard payment network and the Visa payment network. An issuer 125 can be a bank or other institution at which a user has an account and which issues the payment card to the user.

The conventional payment card process flow 100 can begin with a user 105 presenting a form of payment, for example, payment card 150, to purchase goods or services. In some cases, the form of payment can be a physical card or a virtual card (e.g., hosted on a mobile device, and available in an e-wallet).

The payment card 150 can be embedded with a small computer chip, such as an EMV (Europay, Visa, and Mastercard) chip, that can transmit payment details to the merchant/POS 110 (e.g., via a card reader) during a transaction (e.g., via dip or tap methods, depending on capabilities of the circuit on the chip).

The payment card 150 can generate (152) a cryptogram for every purchase. The cryptogram can include payment details, terminal information, and/or transaction data (that may be received from the POS system 110) . For example, the cryptogram can be a string generated by encrypting the payment details, terminal information, and/or transaction data using a key (e.g., data encryption standard (DES) key). The cryptogram generated for each transaction is unique for that transaction. The generated cryptogram can ultimately be used by the issuer 125 for card verification. The generated cryptogram can be sent to the POS system 110 (e.g., via the card reader), as shown in flow (154).

The POS system 110 can receive the cryptogram from the payment card 150. During communications with the payment card 150 (or other payment device), the POS system 110 can extract payment details about the form of payment, such as payment card number, confirmation code, and expiration date. Information obtained by the POS system 110 can also include transaction information about the purchase, such as location, amount, goods type, and a form of verification provided. Some of this information may be obtained from merchant 112 computing devices.

A payment request, comprising at least the cryptogram and the transaction information, can be provided to an acquirer 115 associated with the merchant 112 as shown at flow (156). The acquirer 115 can, in turn, provide the payment request, including the cryptogram, to the payment network 120 as shown at flow (158).

The payment network 120 can identify an issuing bank, or issuer 125, of the user's 105 form of payment (e.g., associated payment card 150). The transaction can be logged to aid in later processes, such as clearing and settlement. The details of the transaction can also be stored in a transaction information storage, which may be associated with the payment network 120. When the payment network 120 identifies the issuer 125, the payment network 120 can send an authorization request, including the cryptogram and some or all of the information included in the payment request, requesting authorization and/or preauthorization on the form of payment from the issuer 125, as shown at flow (160).

The issuer 125 can run the requested authorization or preauthorization. Authorization can include several steps, such as verifying (162) the cryptogram received in the authorization request. For example, to verify (162) the cryptogram, the issuer 125 may attempt to regenerate a same cryptogram using a key stored by the issuer 125. In some cases, where the issuer 125 is able to regenerate a same cryptogram, the payment card is verified and the issuer 125 may authorize the transaction. However, in some cases, where the issuer 125 is unable to regenerate the same cryptogram using the stored key, the issuer 125 can deny authorization for the transaction.

Additionally, authorization can entail ensuring that a transaction is legitimate using other data included in the authorization message, such as by verifying a means of cardholder verification and/or evaluating transaction location, and/or transaction amount.

In some cases, a cardholder verification method (e.g., PIN) can be implemented by the payment card and the result included as part of the cryptogram or transaction message. Accordingly, in addition to verifying the payment card, the issuer 125 can check that the person using the payment card 150 successfully performed a cardholder verification method. For example, when the user 105 presents the payment card 150 to the merchant/POS 110, the user 105 may be prompted to enter a PIN or password. As an additional example, a provided form of cardholder verification can be compared against previously given verification (e.g., PIN, biometrics, or signature) to determine if the user is a legitimate user for the form of payment. The result of the cardholder verification method can be provided to the issuer as the additional layer of security.

As another security measure, an issuer 125 can compare the location against typical spending locations to detect fraudulent charges. Finally, an issuer 125 can determine that a purchase is likely to be too high value to be legitimate and flag the purchase as possibly fraudulent.

The authorization can also check to see if the card is currently locked or suspended. Pre-authorization can entail determining that a user has sufficient credit or account balance to make the transaction. A credit card pre-authorization can be a temporary hold on funds equal to the payment that lasts for a period of time (e.g., 5 days). During the temporary hold, the funds cannot be used anywhere else, but the charge may not actually show up on the statement of the form of payment. After one or more of these checks are performed, the issuer 125 can approve the transaction and forward a payment result indicating success or failure back to the payment network 120 as shown at flow (164).

Once the payment result signal is received, the payment network 120 can forward the signal to the acquirer 115 as shown at flow (166). The acquirer can then forward the signal back to the POS system 110 associated with the merchant 112 as shown at step (168) to confirm that the transaction has been authorized. Later on, settlement and clearing can occur. In clearing, the payment and transaction information can be double checked for accuracy. In settlement, the issuer 125 can transfer funds to the payment network 120; the payment network 120 can then transfer the funds to the acquirer 115. Once the acquirer 115 receives the funds, the funds can be made available to the merchant 112.

As reflected in the flow above, the authorization checks performed as part of a payment card process can include two distinct verification processes: cardholder verification and card verification.

Card verification occurs when the issuer 125 verifies whether the payment card (e.g., payment card 150) is a valid payment card issued by the issuer 125. For example, verifying (162) the cryptogram is an example of card verification.

Notably, conventionally, there is no user-specific data included in the standard cryptogram. As such, the issuer 125 may also perform cardholder verification.

Cardholder verification occurs when the issuer 125 verifies whether the person using the payment card 150 is the actual cardholder or not. Typically, cardholder verification can be facilitated by verifying a credential (e.g., PIN, password, biometric credential), etc. Cardholder verification can also be possession based, like use of a one-time-password or token.

Both card verification and cardholder verification provide security benefits and protect against fraud. However, increasingly, many users are opting to use frictionless transaction methods that do not include cardholder verification. For example, tap transactions are increasingly popular given their frictionless nature-streamlining the customer's experience. However, this convenience comes at the cost of the security benefits inherent to cardholder verification.

In cases where no PIN (or other cardholder verification method) is required, if a payment card is stolen, a transaction can easily be made by the thief, because without cardholder verification, there is no cardholder specific data that is included in the transaction flow.

While many transactions made today don't require cardholder verification (e.g., PIN), most transactions still require successful card verification for successful authorization of a transaction. Conventionally, the card verification process does not include/consider any cardholder data. Therefore, authorization processes that include card verification, but not cardholder verification, suffer from security deficiencies that can be exploited by bad actors.

Advantageously, through the described systems and methods, biometric data of the cardholder can be included into the card verification process-regardless of inclusion of a cardholder verification method-to increase payment card security and further decrease the rate of fraudulent transactions.

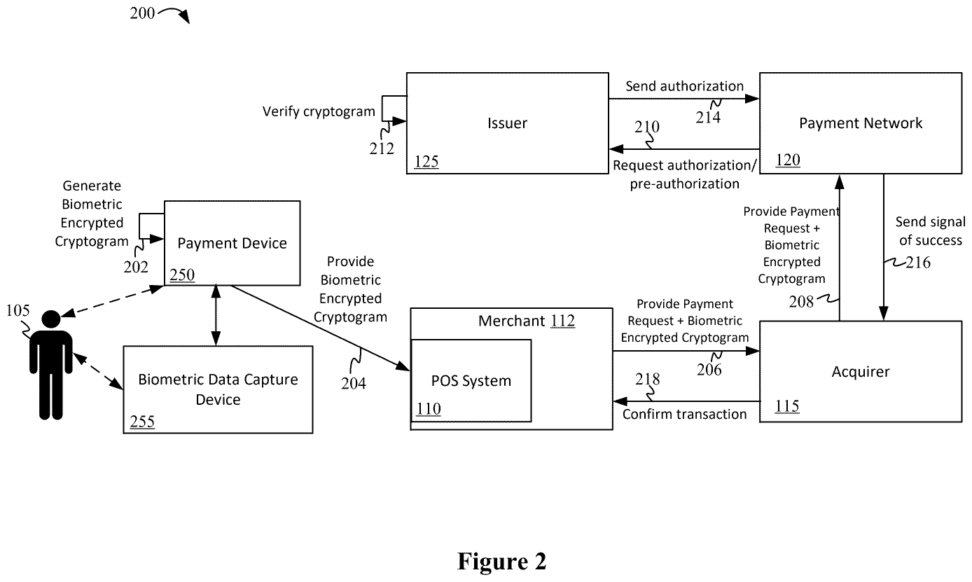

FIG. 2 illustrates an operating environment and example biometric encrypted cryptogram transaction process flow using a payment device.

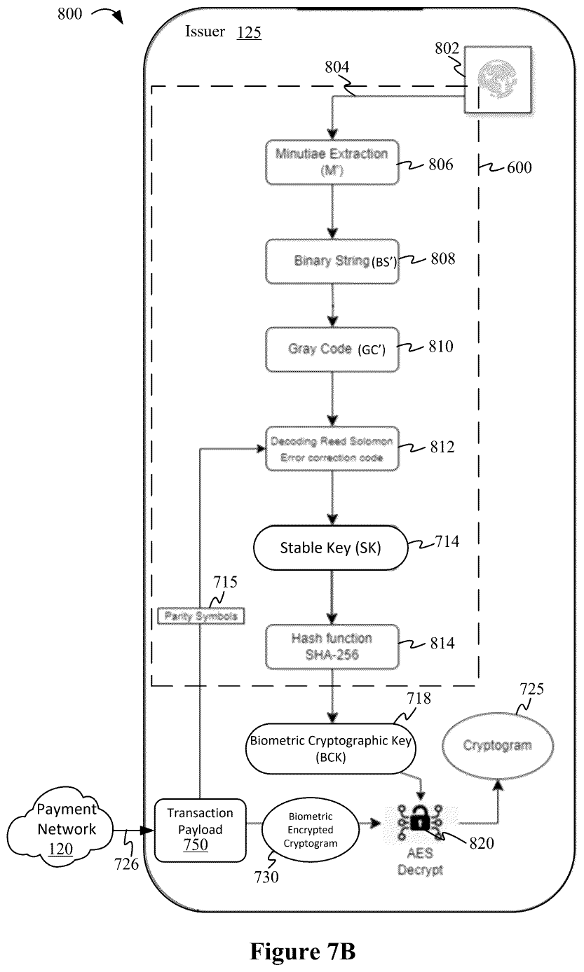

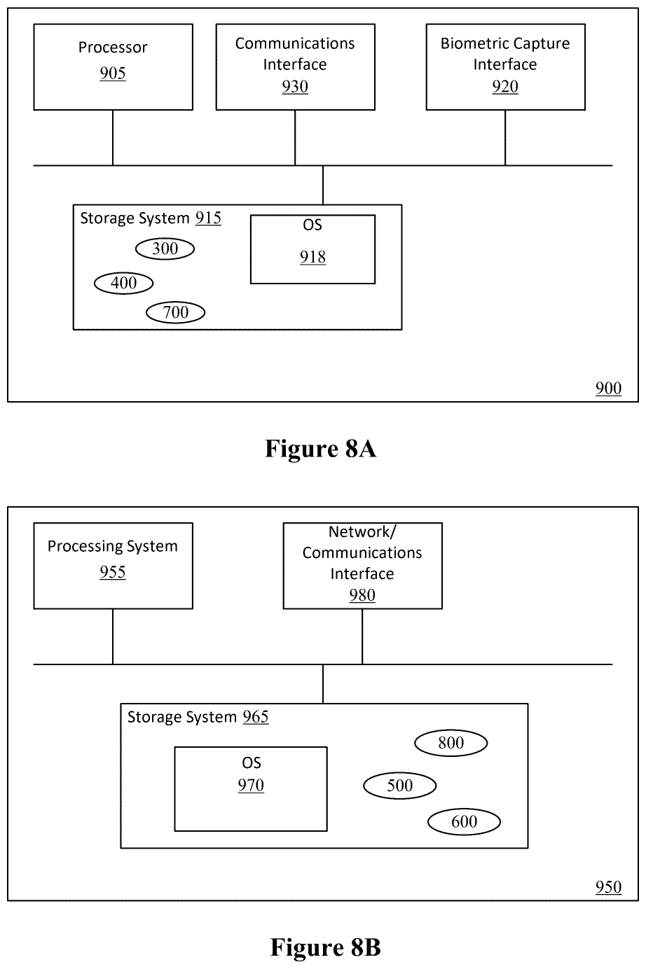

Referring to FIG. 2, the biometric encrypted cryptogram transaction process 200 can begin when the user 105 provides a payment device 250 during a transaction (e.g., to purchase goods and/or services). The payment device 250 can be a physical card or a contactless card (e.g., hosted on a mobile device, and available on an e-wallet). The payment device 250 can be embodied as payment device 900 described with respect to FIG. 8A.

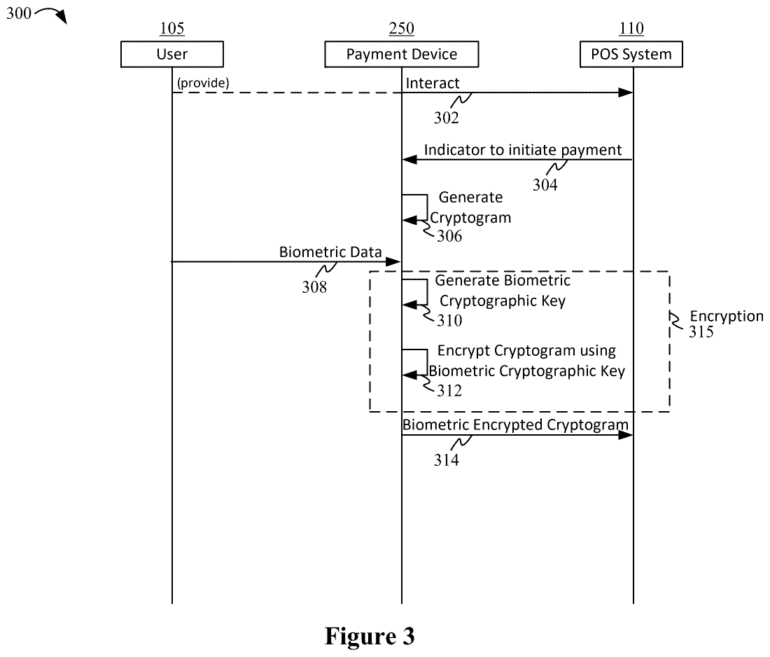

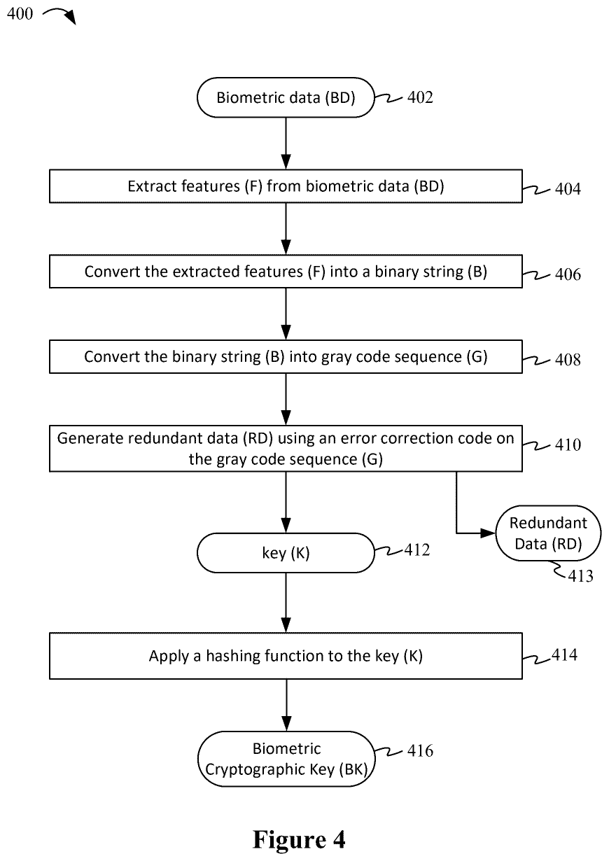

During the transaction, the payment device 250 can generate a biometric encrypted cryptogram and provide the biometric encrypted cryptogram (along with the payment details) to the POS system 110. A biometric encrypted cryptogram is a cryptogram that is additionally encrypted using a biometric cryptographic key generated using biometric data. A process of generating a biometric encrypted cryptogram is described in more detail with respect to FIG. 3 and an example implementation of generating a biometric encrypted cryptogram from a fingerprint is described with respect to FIG. 4.

For example, as described herein, to generate (202) the biometric encrypted cryptogram, the payment device 250 first generates a standard cryptogram typically used in payment card transactions (e.g., operation (152) described with respect to FIG. 1). However, instead of providing the standard cryptogram to the POS system 110 (e.g., for use in verification at the issuer 125), the generated cryptogram is further encrypted as a biometric encrypted cryptogram.

In particular, the payment device 250 can receive biometric data of the user 105 and use the biometric data to generate a biometric cryptographic key that is used to encrypt the standard cryptogram.

The biometric data of the user 105 is received through a biometric data capture device 255. In some cases, the biometric data capture device 255 is part of the payment device 250 (e.g., biometric capture interface 920 described with respect to FIG. 8A). For example, the payment device 250 may be a biometrics card configured to receive fingerprint data (e.g., biometric data) from the user 105. In some cases, the payment device 250 can be a mobile device and the biometrics data can be a facial scan, a fingerprint, or other biometric data received via a sensor associated with the mobile device. In some cases, the biometric data capture device 255 can be external to the payment device 250. For example, the biometric data capture device 255 may be part of/coupled to the POS system 110 and the biometric data of the user 105 captured by the biometric data capture device 255 can be provided to the payment device 250 via the POS system 110 (not shown).

Accordingly, upon receiving biometric data of the user 105, the payment device 250 can generate a biometric cryptographic key using the biometric data of the user 105 received via the biometric data capture device 255 and the biometric encrypted cryptogram is provided (204) to the POS system 110.

Once the POS system 110 receives the payment details and the biometric encrypted cryptogram, the POS system 110 can generate a payment request, including the biometric encrypted cryptogram, the payment details, and/or transaction information (e.g., merchant location, transaction amount, goods type, etc.). The information included in the payment request can also be referred to as a “transaction payload.”

The POS system 110 can provide the payment request, including the biometric encrypted cryptogram, to the acquirer 115 associated with merchant 112, as shown in flow (206). The acquirer 115 can, in turn, provide the payment request to the payment network 120, as shown at flow (208). The payment network 120 can identify an issuing bank, or issuer 125, associated with the payment device 250 (e.g., as indicated by payment details included in the payment request). The payment network 120 can send (210) an authorization request (including the biometric encrypted cryptogram and some or all of the information included in the payment request) requesting authorization and/or preauthorization on the payment device 250 for the transaction, as shown at flow (210).

The issuer 125 can run the requested authorization and/or preauthorization. Authorization and/or preauthorization can include several steps, including verifying (212) the biometric encrypted cryptogram.

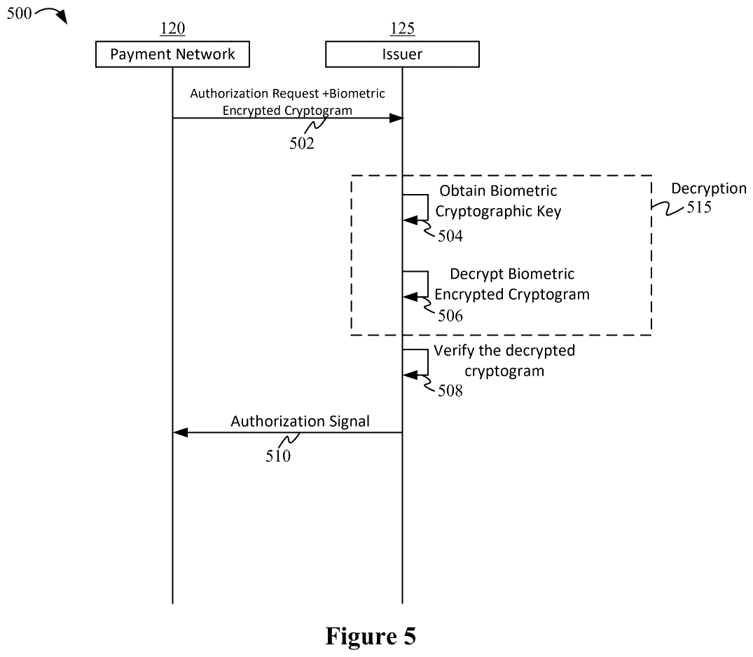

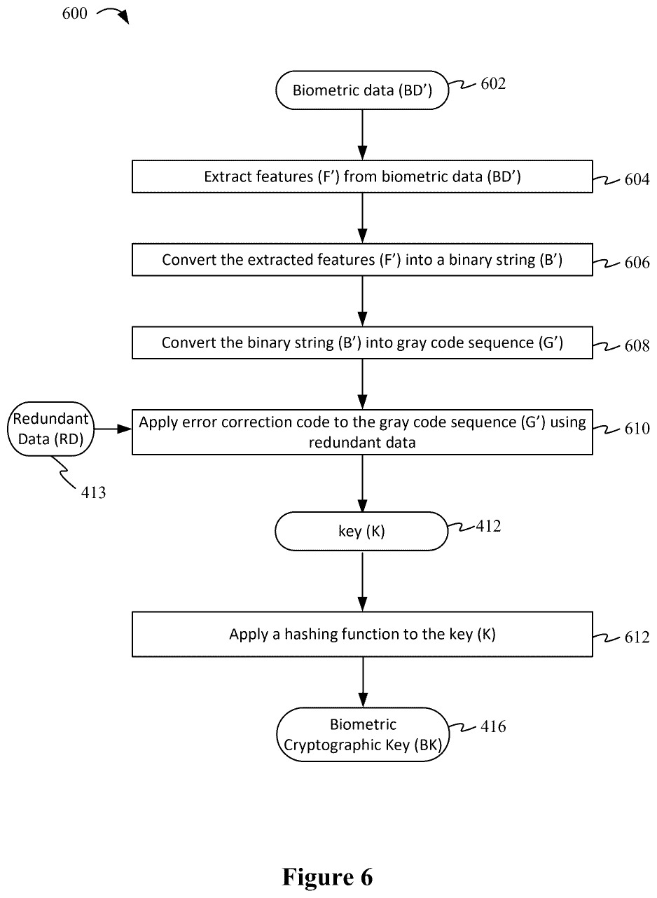

In order to verify (212) the biometric encrypted cryptogram, the issuer 125 must decrypt the biometric encrypted cryptogram using a biometric cryptographic key. An example process of decrypting a biometric encrypted cryptogram at the issuer 125 is described in more detail with respect to FIG. 5 and an example implementation is described with respect to FIG. 6.

For example, the issuer 125 can use biometric data of the user 105 stored in a storage resource associated with the issuer 125 to generate the biometric cryptographic key used to decrypt the biometric encrypted cryptogram.

Advantageously, regardless of use of a cardholder verification method, additional security is achieved since the issuer 125 will only be able to decrypt the biometric encrypted cryptogram that was generated at the payment device 250 using a biometric cryptographic key generated using biometric data of the user 105.

For example, if at flow (202), instead of the user 105, a fraudulent actor is attempting to make the transaction using the payment device 250, the biometric encrypted cryptogram would be generated using a biometric cryptographic key generated using biometric data of the fraudulent actor or would entirely lack the appropriate encryption. As such, when the issuer 125 attempts to decrypt the biometric encrypted cryptogram using biometric data of the user 105, the attempt would fail, because the biometric cryptographic keys would not sufficiently match (and thereby not result in the ability to decrypt the cryptogram used to authorize the transaction). Therefore, if someone other than the user 105 attempts to conduct a transaction using the payment device 250, the issuer 125 will be able to identify this as fraudulent activity based on the failure to decrypt the biometric encrypted cryptogram received with the authorization request.

If the biometric encrypted cryptogram generated (202) at the payment device 250 was generated using biometric data of the user 105, the issuer 125 will be able to decrypt the biometric encrypted cryptogram and extract the standard cryptogram.

Once the standard cryptogram is extracted, the issuer 125 can at least verify (212), as shown at flow (212) (among other checks/determinations performed during the authorization/preauthorization), the issuer 125 can approve the transaction and forward a payment result indicating success back to the payment network 120, as shown at flow (214). If the issuer 125 is unable to decrypt the biometric encrypted cryptogram, the issuer 125 can deny the transaction and forward a payment result indicating a failure back to the payment network 120.

As with the flow described with respect to FIG. 1, once the payment result signal is received, the payment network 120 can forward the signal to the acquirer 115 as shown at flow (216). The acquirer 115 can then forward the signal back to the merchant 112/POS system 110 as shown at step (218) to confirm that the transaction has been authorized. Later on, settlement and clearing can occur.

Advantageously, by encrypting the biometric encrypted cryptogram using biometric data unique to the cardholder in the form of a biometric cryptographic key, the transaction process flow is more secure than a conventional transaction process flow.

FIG. 3 illustrates an example process for generating a biometric encrypted cryptogram. Referring to FIG. 3, the process 300 for generating a biometric encrypted cryptogram can begin when a payment device 250 interacts (302) with a point-of-sale (POS) system 110. The payment device 250 can interact (302) with the POS system 110 via a communications interface of the payment device 250 (e.g., communications interface 930 described with respect to FIG. 8A). For example, the user 105 can tap the payment device 250 at the POS system 110 or insert the payment device 250 into a card chip reader of the POS system 110.

Upon interacting (302) with the POS system 110, the payment device 250 can receive (304) an indicator to initiate payment for a transaction from the POS system 110. The indicator can include transaction information and/or terminal information, including, but not limited to, transaction amount, transaction date, transaction type, terminal country code, terminal verification results, transaction currency code, and an unpredictable number. The unpredictable number can be a unique 4-byte field generated by the POS system 110.

In response to receiving (304) the indicator, the payment device 250 can generate (306) a cryptogram for the transaction. Generating (306) the cryptogram can include encrypting transaction data elements using a key (e.g., a data encryption standard (DES) key). The transaction data elements can include the transaction information and/or terminal information included in the indicator, as well as data elements generated/maintained at chip level at the payment device 250, for example application transaction counter and application interchange profile.

Notably, instead of the payment device 250 simply providing the cryptogram generated (306) using payment details, terminal information, and/or transaction information, this standard cryptogram is encrypted by the payment device 250 a second time using a biometric cryptographic key generated using biometric data of the user 105.

The payment device 250 receives (308) biometric data from the user 105 (e.g., via a biometric data capture device 255). In some cases, during the transaction, the payment device 250 and/or the POS system 110 may prompt the user 105 to provide a biometric credential (e.g., face, fingerprint, etc.).

Once the payment device 250 has received (308) the biometric data of the user 105 the payment device 250 can encrypt (315) the cryptogram using a biometric cryptographic key generated using the biometric data received (308) from the user 105.

To generate the biometric encrypted cryptogram, the payment device 250 uses a symmetric-key algorithm for encryption 315. A symmetric-key algorithm involves the same cryptographic keys for both the encryption of the plaintext (e.g., encryption (312) of cryptogram using a biometric cryptographic key at payment device 250) and the decryption of the ciphertext (e.g., decryption (506) of the biometric encrypted cryptogram using the biometric cryptographic key at the issuer 125, as described with respect to FIG. 5). For example, the symmetric-key algorithm can be the Advanced Encryption Standard (AES). Any symmetric-key algorithm can be used for the encryption, so long as the same symmetric-key algorithm is used for decryption by the issuer 125. Additional examples of symmetric-key algorithms include, but are not limited to, Twofish, Serpent, Camellia, Salsa20, and Blowfish.

Encryption 315 can include generating (310) the biometric cryptographic key and encrypting (312) the cryptogram using the biometric cryptographic key. An example method for generating the biometric cryptographic key using the biometric data is described in more detail with respect to FIG. 4. Any process that transforms the biometric data of the user into an appropriately sized key for a symmetric-key algorithm may be used. In addition, an error correction code is applied so that generating (310) the biometric cryptographic key produces redundant data, which is included in the transaction payload to the issuer so that the issuer can generate a symmetrical biometric cryptographic key used to decrypt the biometric encrypted cryptogram even where the biometric data may not be captured exactly at both places.

Once the biometric cryptographic key has been generated (310), the payment device 250 encrypts (312) the cryptogram (i.e., the cryptogram generated at step (306)) using the biometric cryptographic key to generate a biometric encrypted cryptogram. The cryptogram can be encrypted (312) with the biometric cryptographic key using the symmetric-key algorithm.

Then, the payment device 250 can provide (314) the biometric encrypted cryptogram to the POS system 110 for authorization of the transaction (e.g., to be included in the payment request). In some cases, the payment device 250 can provide the redundant data generated during the generation of the biometric cryptographic key to the POS system 110.

As described with respect to FIG. 2, ultimately, during the transaction flow 200, once the POS system receives 110 the biometric encrypted cryptogram (and other payment details), the POS system 110 can send the payment request, including the biometric encrypted cryptogram, to the issuer 125 for authorization/preauthorization of the transaction.

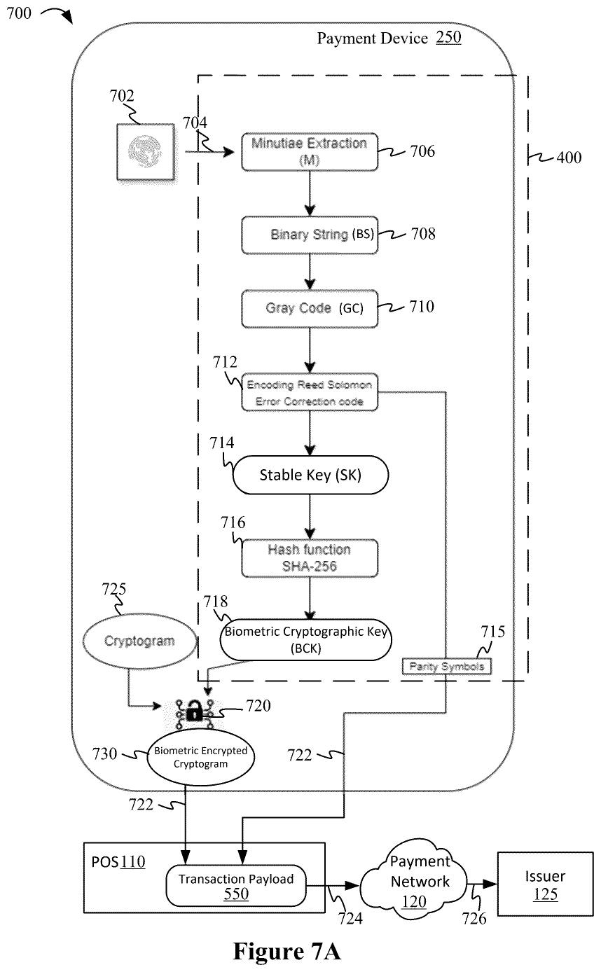

FIG. 4 illustrates an example method for generating a biometric cryptographic key at a payment device. Referring to FIG. 4, the method 400 can begin in response to receiving biometric data (BD) 402 of a user. The method 400 can be performed at a payment device (e.g., payment device 250 described with respect to FIG. 2). Examples of biometric data (BD) 402 include, but are not limited to, fingerprint data, facial scan data, and iris data. A specific use case for generating a biometric cryptographic key at a payment device using fingerprint data is described with respect to FIG. 7A.

Method 400 can include extracting (404) features (F) from the biometric data (BD) 402. The features (F) can be extracted (404) by a suitable method/algorithm based on the type of biometric data (e.g., fingerprint data, face scan data, etc.).

The extracted features (F) can be converted (406) into a binary string (B). Then, the binary string can be converted (408) into a gray code sequence (G). Gray code, also referred to as reflected binary code (RBC), is an ordering of the binary numeral system such that two successive values differ in only one bit (binary digit). Gray code can be used to result in a minimum bit change for very small changes in input.

The obtained gray code sequence (G) forms key (K) 412. In some cases, the key (K) 412 is a stable key. Additionally, an error correction code can be used on the gray code sequence (G) to generate (410) redundant data (RD) 413.

Examples of the error correction code can include, but are not limited to, Reed-Solomon code and Hadamard code. By applying the error correction code on the gray code sequence (G), redundant data (RD) 413 is generated (410). This redundant data (RD) 413 can be provided to the issuer (e.g., in the transaction payload/payment request) to be used during the key generation during the decryption process to correct erroneous bits in the regenerated gray code sequence generated on the issuer side (e.g., (G′)). In order for the issuer to be able to decrypt the resulting biometric encrypted cryptogram encrypted using the biometric cryptographic key (BK) 416, the issuer (e.g., issuer 125) must generate an identical biometric cryptographic key 416. However, the biometric data (BD) 402 used by the payment device 250 to create key string (K) 412, and ultimately biometric cryptographic key (BK) 416, may have slight variations from the biometric data used by the issuer (e.g., biometric data (BD′) 406 described with respect to FIG. 6). For example, a fingerprint scan image received at the payment device 250 and a fingerprint scan image for the same finger received at the issuer may not be exactly the same.

Therefore, when the decryption method is performed at the issuer, a slightly different gray code sequence (e.g., gray code sequence (G′)) is created. Therefore, because the issuer will need an identical biometric cryptographic key (BK) 412, an error correction code can be used during both the encryption process at the payment device 250 and during decryption at the issuer.

Once the key (K) 412 is generated, a hashing function can be applied (414) to the key (K) 412 to create the biometric cryptographic key (BK) 416. The hashing function can be applied to convert the key (K) 412 to a fixed length. The hashing function can be chosen based on the key size requirement for the symmetric-key algorithm to be used to encrypt the standard cryptogram (e.g., encryption 315 described with respect to FIG. 3) because various cryptographic algorithms can have different key size requirements. Examples of the hashing function can include the SHA-256 algorithm.

Once created, the biometric cryptographic key (BK) 416 can be used by the encryption algorithm (e.g., AES algorithm) to encrypt the standard cryptogram to generate a biometric encrypted cryptogram. The biometric encrypted cryptogram, along with the redundant data (RD) 413 can be provided to the POS system 110, (e.g., as shown in flow (204) of FIG. 2 and operation 314 of FIG. 3), for use by the issuer 125 during authorization.

As described above, once an issuer 125 receives an authorization request including a biometric encrypted cryptogram and before the issuer 125 can verify the cryptogram, the issuer 125 must first decrypt the biometric encrypted cryptogram.

FIG. 5 illustrates an example process for decrypting a biometric encrypted cryptogram at an issuer.

Referring to FIG. 5, the example process 500 for decrypting a biometric encrypted cryptogram can begin when an issuer 125 receives (502) an authorization request for a transaction that includes a biometric encrypted cryptogram and the redundant data. In some cases, the issuer 125 can receive the authorization request from a payment network 120. The authorization request can include payment details, transaction information, and the biometric encrypted cryptogram.

To decrypt the biometric encrypted cryptogram, the issuer 125 uses a same symmetric-key algorithm for decryption 515 that was used for encryption (e.g., the same algorithm used as part of encryption 315 of FIG. 3). For example, if the AES algorithm is used to encrypt the biometric encrypted cryptogram, the AES algorithm is used by the issuer 125 to decrypt the biometric encrypted cryptogram. Decryption (515) can include obtaining (504) the biometric cryptographic key and decrypting (506) the biometric encrypted cryptogram using the biometric cryptographic key.

The issuer 125 can obtain (504) a biometric cryptographic key generated using biometric data of a user.

In some cases, obtaining (504) the biometric cryptographic key can include generating the biometric cryptographic key. An example process for generating a biometric cryptographic key at an issuer is described in more detail with respect to FIG. 6.

In some cases, obtaining (504) the biometric cryptographic key can include identifying a payment card associated with the transaction (e.g., using the payment details included in the authorization request). Upon identifying the payment card associated with the transaction, the issuer 125 can retrieve (e.g., from a storage device) biometric data associated with the user associated with the payment card and generate the biometric cryptographic key.

In some cases, instead of storing the biometric data of a user, the issuer 125 can instead store a gray code sequence generated using the biometric data of the user. In this case, upon identifying the payment card associated with the transaction, the issuer 125 can retrieve (e.g., from the storage device), the gray code sequence generated using the biometric data of the user and generate the biometric cryptographic key.

The issuer 125 can then decrypt (506) the biometric encrypted cryptogram using the biometric cryptographic key to extract the cryptogram.

Once the biometric encrypted cryptogram has been decrypted to extract the cryptogram, the issuer 125 can verify (508) the cryptogram using conventional processes. In response to verifying (508) the cryptogram, the issuer 125 can send (510) an authorization signal for the transaction, as described in more detail with respect to FIG. 2.

As discussed herein, the biometric cryptographic key generated by the issuer is symmetrical to the biometric cryptographic key generated at the payment device. As such, the issuer must use biometric data of the same biometric credential used to generate the biometric cryptographic key at the payment device. For example, if the user wishes to use their right index fingerprint as the biometric credential during the transaction flow, the user must provide biometric data associated with the right index fingerprint to the issuer prior to the transaction.

Additionally, the same symmetric-key algorithm must be used by both the payment device and the issuer to generate the biometric cryptographic key that is used to encrypt/decrypt the biometric encrypted cryptogram.

FIG. 6 illustrates an example method for generating a biometric cryptographic key at an issuer. Referring to FIG. 6, the method 600 can begin with biometric data (BD′) 602 of a user. The method 600 can be performed at an issuer (e.g., issuer 125 described with respect to FIG. 2).

In some cases, the user can provide biometric data (BD′) 602 to the issuer via an application associated with the issuer executing on a computing device (e.g., mobile device, personal computer, etc.). In some cases, the user may provide biometric data to the issuer upon signing up for a biometrics payment card. Examples of biometric data (BD′) 602 include, but are not limited to, fingerprint data, facial data, and iris data. A specific use case for generating a biometric cryptographic key at an issuer using fingerprint data is described with respect to FIG. 7B.

Method 600 can include extracting (604) features (F′) from the biometric data (BD′) 602. The features (F′) can be extracted (604) by a suitable extraction method/algorithm based on the type of biometric data (e.g., fingerprint data, face scan data, etc.). The same extraction method/algorithm should be used in both method 400 performed by the payment device described with respect to FIG. 4 and method 600 performed by the issuer of that payment device.

Referring to FIG. 4 and FIG. 6, as discussed herein, the features (F′) extracted at step (604) may be different from features (F) extracted at step (404) of method 400 described with respect to FIG. 4. This is because biometric data (BD) 402 and biometric data (BD′) 602 may have slight variations and the feature extraction process may not yield identical results.

For example, if a first fingerprint scan of a user's right index finger is used to generate biometric data (BD) 402 and a second fingerprint scan of the same user's right index finger is used to generate biometric data (BD′) 602, there can be slight differences in the data captured and, resultingly, differences in the features extracted. However, if the same biometric credential (e.g., right index finger) is used to generate the biometric data (BD) 402 and biometric data (BD′) 602 features (F) and features (F′), the features (F′) will be similar enough that, once the error correction code is applied, the resulting keys (K) will be the same.

The extracted features (F′) can be converted (606) into a binary string (B′). Similarly, binary string (B′) will be slightly different than binary string (B) of method 400.

Then, the binary string (B′) can be converted (608) into gray code sequence (G′). Gray code sequence (G′) will be slightly different than gray code sequence (G) created via method 400.

It should be noted that steps (604)-(608) can occur at any time prior to the transaction. As mentioned above, in some cases, the gray code sequence (G′) can be stored by the issuer in addition to or in place of the biometric data associated with the payment card and the user. As such, when the issuer receives the authorization request including the biometric encrypted cryptogram, the issuer only needs to perform steps (610)-(612) to obtain the biometric cryptographic key (BK) 416 (e.g., as shown in step (504) of FIG. 5).

During a transaction flow (e.g., 200 described with respect to FIG. 2), the issuer can receive redundant data (RD) 413 along with the biometric encrypted cryptogram (e.g., in the authorization request). Then, using the redundant data (RD) 413, the same error correction code used in method 400 described with respect to FIG. 4 is used to correct gray code sequence (G′) to obtain the same key (K) 412. By applying the same error correction code, a symmetrical key (K) 412 to the one generated at the payment device 250 for encryption (e.g., via method 400 described with respect to FIG. 4) is generated at the issuer side for decryption.

The error correction code can be applied (610) on the gray code sequence (G′) using the redundant data (RD) 413 to perform error correction to generate key (K) 412.

Notably, in some cases, when the biometric encrypted cryptogram was generated at the payment device using different biometric data, applying (610) the error correction code on the gray code sequence (G′) using the redundant data (RD) will fail to generate key (K) 412. In this case, the issuer may stop the verification process here, because the issuer can determine that someone other than the user initiated the transaction using the payment device.

Once the key (K) 412 has been generated, method 600 can include applying (612) a hashing function to key (K) 412 to generate the biometric cryptographic key (BK) 416. The same hashing function that is used at step (412) of method 400 should be used to obtain symmetrical biometric cryptographic key (BK) 416. For example, the hashing function can be SHA-256 algorithm.

Then, the generated symmetrical biometric cryptographic key (BK) 416 can be used by the issuer to decrypt the biometric encrypted cryptogram (e.g., using AES algorithm) to extract the cryptogram.

FIG. 7A-7B illustrates an example use case of a biometric encrypted cryptogram transaction process flow. Referring to FIG. 7A, process flow 700 includes an example use case of method 400 as described with respect to FIG. 4.

The process flow 700 can begin when the payment device 250 receives (704) fingerprint data 702 (e.g., a fingerprint image). The payment device 250 can perform (706) minutiae extraction to extract features (M) from the fingerprint data 702. The resulting features extracted from the fingerprint data (e.g., ridge ending and ridge bifurcation points) can be referred to as “minutiae points.” The extracted features (M) can be converted into a sequence of integers.

Then, the payment device 250 can convert (708) the extracted features (M) (e.g., the sequence of integers) into a binary sequence, creating binary string (BS).

Then, the payment device 250 can convert (710) the binary string (BS) into a gray code sequence (GC). The obtained gray code sequence (GC) provides a stable key (SK) 714.

Then, the payment device 250 can use (712) Reed-Solomon code on the gray code sequence (GC) to generate parity symbols 715 (e.g., redundant data). Using (712) Reed-Solomon code, the exact cryptographic key that is generated at the payment device 250 for encryption can be generated again at the issuer side for decryption. In order for Reed-Solomon code to work, certain parity symbols 715 are created as part of the Reed-Solomon error correction algorithm. These parity symbols 715 are provided to the issuer 125 (e.g., the redundant data provided as part of the transaction payload 550) so that they are available for use during decryption.

Once the stable key (SK) 714 is created, the payment device 250 can apply (716) a S HA-256 hash function to the stable key (SK) 714 to convert the stable key (SK) 714 to a fixed length of 256 bits, creating a biometric cryptography key (BCK) 718.

The biometric cryptographic key (BCK) 718 is used to encrypt (720) the standard cryptogram 725 using AES encryption to create a biometric encrypted cryptogram 730.

Then, the payment device 250 can provide (722) the biometric encrypted cryptogram 730 and the parity symbols 715 to the POS system 110. The POS system 110 can include the biometric encrypted cryptogram 730 and the parity symbols 715 in the transaction payload 750 (e.g., in the payment request). The POS system 110 can provide the transaction payload 750 to the payment network 120 (e.g., via acquirer 115), as shown at step (724). The payment network 120 can send the transaction payload 750 to the issuer 125 (e.g., in an authorization request), as shown at step (726).

Referring to FIGS. 7A-7B, the process flow 800 can begin when an issuer 125 receives the transaction payload 750, as shown at step (726). The transaction payload 750 includes the biometric encrypted cryptogram 730 and the parity symbols 715. To decrypt the biometric encrypted cryptogram, the issuer 125 first must generate biometric cryptographic key (BCK) 718. Process flow 800 includes an example use case of method 600 as described with respect to FIG. 6.

The issuer 125 can obtain (804) fingerprint data 802 (e.g., a fingerprint image). The issuer 125 can perform (806) minutiae extraction to extract features (M′) from the fingerprint data 802. In this case, the extracted features (M′) are slightly different than the extracted features (M) as described with respect to FIG. 7A. The extracted features (M′) can be converted into a sequence of integers.

Then, the issuer 125 can convert (808) the extracted features (M′) (e.g., sequence of integers) into a binary sequence to produce binary string (BS′).

Then, the issuer 125 can convert (810) the binary string (BS′) into a gray code sequence (GC′).

The gray code sequence (GC′) generated using the fingerprint data 802 includes slight variations from the gray code sequence (GC) generated at step (710) in process flow 700. As such, where the gray code sequence (GC) is used as the stable key (SK), gray code sequence GC′ would not create a symmetrical key to stable key (SK).

However, in order to decrypt the biometric encrypted cryptogram 730, the exact biometric cryptographic key (BCK) 718 that is generated at the payment device 250 needs to be re-generated again at the issuer 125 side for decryption. However, because the biometric data 702 received (704) by the payment device 250 and the biometric data 802 stored by the issuer 125 may have slight variations, the biometric cryptographic keys generated based on the different biometric data would likely turn out to be different. However, if the biometric cryptographic keys are different, then the issuer will be unable to decrypt the biometric encrypted cryptogram to extract the original cryptogram.

Therefore, the issuer 125 can apply (812) Reed-Solomon code to the gray code sequence (GC′) using the parity symbols 715 received in the transaction payload 750. Reed-Solomon code corrects the changed bits from the gray code sequence (GC′) back to the encryption key, but only up to a certain number. Therefore, if the encryption key is done using biometric data 702 of the actual cardholder, then a very small number of bits needs to be corrected. However, when the encryption key is generated using an imposter's fingerprint data, there will be too much of a difference between the biometric cryptographic keys and the Reed-Solomon code will be unable to correct the number of bits needed to generate the symmetrical stable key (SK) 714.

Once the stable key (K) 714 is created by applying (812) Reed-Solomon code to the gray code sequence (GC′), the issuer 125 can apply (814) a SHA-256 hash function to the stable key (K) 714 to convert the stable key (SK) 714 to a fixed length, creating a biometric cryptography key (BCK) 718.

The biometric cryptographic key (BCK) 718 can then be used to decrypt (820) the biometric encrypted cryptogram 730 using AES encryption to extract the standard cryptogram 725.

Then, the issuer 125 can then proceed with the transaction flow as described with respect to FIG. 2. For example, the issuer 125 may then verify the cryptogram 725.

FIG. 8A illustrates components of a payment device that may be used in certain embodiments described herein.

Referring to FIG. 8A, payment device 900 may include a designated payment instrument such as a payment card (e.g., smart card or chip card including EMV chip) or a computing device that supports payments (e.g., through a wallet, mobile application, or web application). Examples of payment device 900 include, but are not limited to, a biometric payment card, a mobile device, a personal computer, a personal digital assistant, a wearable computer, a smart phone, a tablet, a laptop computer (notebook or netbook), a gaming device or console, an entertainment device, a hybrid computer, a desktop computer, or a smart television. Accordingly, more or fewer elements described with respect to payment device 900 may be incorporated to implement a particular payment device. Payment device 900 includes a processing system 905 of one or more hardware processors to transform or manipulate data according to the instructions of software stored on a storage system 915. Processing system 905 can include a secure processor (e.g., for performing encryption) and a general processor. Examples of processors of the processing system 905 include general purpose central processing units, application specific processors, and logic devices, as well as any other type of processing device, combinations, or variations thereof. The processing system 905 may be, or is included in, a system-on-chip (SoC) along with one or more other components such as network connectivity components, memory, and sensors.

Storage system 915 may include volatile and nonvolatile memories, removable and non-removable media implemented in any method or technology for storage of information, such as computer readable instructions, data structures, program modules, or other data. In various implementations, storage system 915 includes secure storage (e.g., for storing cryptogram, keys, and other data and code) and general storage. Examples of storage media of storage system 915 include random access memory (e.g., DRAM, SRAM), read only memory (ROM), and flash. In no case is the storage medium a transitory propagated signal.

The storage system 915 can store an operating system 918, various software, and data. Software at the storage system 915 may be implemented in program instructions and among other functions may, when executed by payment device 900 (or by processor 905 in particular), direct payment device 900 to operate as described herein, including implementations of process 300, method 400, and process 700.

Biometric capture interface 920 may represent an interface for capturing biometric data, such as, but not limited to, a scanner (e.g., fingerprint scanner), sensor, or a camera device

The payment device 900 can further include a communications interface 930. In some cases, the communications interface 930 includes a contact portion including input/output (I/O) port to support contact with pads at a POS system. Communications interface 930 may be configured for wireless communication. In some cases, communications interface 930 supports radio frequency communication, near field communication (NFC), Bluetooth®, etc.).

FIG. 8B illustrates components of a computing system that may be used in certain embodiments described herein. Computing system 950 can embody computing systems of a merchant, acquirer, payment network, and issuer for implementing operations as described with respect to the merchant, acquirer, payment network, and issuer herein.

Referring to FIG. 8B, system 950 can include one or more blade server devices, personal computers, routers, hubs, switches, bridges, firewall devices, intrusion detection devices, mainframe computers, network-attached storage devices, and other types of computing devices. The system hardware can be configured according to any suitable computer.

The system 950 can include a processing system 955, which may include one or more processors and/or other circuitry that retrieves and executes software from the storage system 965.

The processing system 955 may be implemented within a single processing device but may also be distributed across multiple processing devices or sub-systems that cooperate in executing program instructions.

The storage system 965 can store an operating system 970 and software for executing various implementations of processes 500 and 800 and method 600 described herein.

Storage system 965 may include volatile and nonvolatile memories, removable and non-removable media implemented in any method or technology for storage of information, such as computer readable instructions, data structures, program modules, or other data. Examples of storage media of storage system 965 include random access memory, read only memory, magnetic disks, optical disks, CDs, DVDs, flash memory, magnetic cassettes, magnetic tape, magnetic disk storage or other magnetic storage devices, or any other suitable storage media. In no case is the storage medium a transitory propagated signal.

Storage system 965 may be implemented as a single storage device but may also be implemented across multiple storage devices or sub-systems co-located or distributed relative to each other. Storage system 965 may include additional elements, such as a controller, capable of communicating with processing system 955. The storage system 965 may also include storage devices and/or sub-systems on which data is stored. System 950 may access one or more storage resources in order to access information to carry out any of the processes (e.g., process 500 and 800 and method 600) indicated by software.

Software at the storage system 965 may be implemented in program instructions and among other functions may, when executed by system 950 in general or processing system 955 in particular, direct system 950 or the one or more processors of processing system 955 to operate as described herein.

Network interface 980 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS 970, which informs applications of communications events when necessary.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A payment device, comprising:
a processing system;
a communications interface;
one or more storage media; and
instructions stored on the one or more storage media that, when executed by the processing system, direct the payment device to at least:
receive an indicator to initiate payment for a transaction;
in response to receiving the indicator, generate a cryptogram for the transaction;
receive biometric data of a user;
generate a biometric cryptographic key using the biometric data;
encrypt the cryptogram using the biometric cryptographic key to generate a biometric encrypted cryptogram; and
provide the biometric encrypted cryptogram to a point-of-sale (POS) system for authorization of the transaction.

2. The payment device of claim 1, wherein the instructions to generate the biometric cryptographic key direct the payment device to:
extract features from the biometric data;
convert the extracted features into a binary string;
convert the binary string into a gray code sequence, wherein the gray code sequence forms a key;
generate redundant data using an error correction code on the key formed by the gray code sequence; and
apply a hashing function to the key formed by the gray code sequence to create the biometric cryptographic key.

3. The payment device of claim 2, wherein the instructions further direct the payment device to provide the redundant data to the POS system for the authorization of the transaction.

4. The payment device of claim 2, wherein the instructions to generate redundant data using the error correction code direct the payment device to generate parity symbols using a Reed-Solomon code on the key formed by the gray code sequence.

5. The payment device of claim 2, wherein the hashing function is a SHA-256 hash function.

6. The payment device of claim 2, wherein the biometric data is a fingerprint image, wherein the instructions to extract features from the biometric data direct the payment device to extract features from the fingerprint image using minutiae extraction.

7. The payment device of claim 1, further comprising a biometric capture interface, wherein the biometric data of the user is received via the biometric capture interface.

8. The payment device of claim 7, wherein the payment device is a biometric payment card.

9. The payment device of claim 1, wherein the biometric cryptographic key is generated using a symmetric-key algorithm.

10. A method, comprising:
receiving an authorization request for a transaction, wherein the authorization request comprises a biometric encrypted cryptogram;
obtaining a biometric cryptographic key generated using biometric data of a user;
decrypting the biometric encrypted cryptogram using the biometric cryptographic key to extract a cryptogram;
verifying the cryptogram; and
sending an authorization signal for the transaction in response to verifying the cryptogram.

11. The method of claim 10, wherein the authorization request comprises redundant data associated with the biometric encrypted cryptogram, and wherein obtaining the biometric cryptographic key comprises:
generating the biometric cryptographic key, wherein generating the biometric cryptographic key comprises:
extracting features from the biometric data of the user;
converting the extracted features into a binary string;
converting the binary string into a gray code sequence;
applying error correction to the gray code sequence using the redundant data to generate a key; and
applying a hashing function to the key to create the biometric cryptographic key.

12. The method of claim 11, wherein the redundant data comprises parity symbols, wherein applying error correction to the gray code sequence comprises applying Reed-Solomon error correction to the gray code sequence using the parity symbols.

13. The method of claim 11, wherein the biometric data of the user is a stored fingerprint image.

14. The method of claim 10, wherein the authorization request comprises redundant data associated with the biometric encrypted cryptogram, wherein the biometric data of the user is a stored gray code sequence generated by extracting features from the biometric data of the user, converting the extracted features into a binary string, and converting the binary string into the gray code sequence, and wherein obtaining the biometric cryptographic key comprises:
generating the biometric cryptographic key by:
applying error correction to the stored gray code sequence using the redundant data to generate a key; and
applying a hashing function to the key to create the biometric cryptographic key.

15. A computer readable storage medium having instructions stored thereon that when executed by a processing system, direct the processing system to at least:
receive an indicator to initiate payment for a transaction;
in response to receiving the indicator, generate a cryptogram for the transaction;
receive biometric data of a user;
generate a biometric cryptographic key using the biometric data;
encrypt the cryptogram using the biometric cryptographic key to generate a biometric encrypted cryptogram; and
provide the biometric encrypted cryptogram to a point-of-sale (POS) system for authorization of the transaction.

16. The computer readable storage medium of claim 15, wherein the instructions to generate the biometric cryptographic key further direct the computing system to:
extract features from the biometric data;
convert the extracted features into a binary string;
convert the binary string into a gray code sequence, wherein the gray code sequence is a key;
generate redundant data using an error correction code on the gray code sequence; and
apply a hashing function to the key to create the biometric cryptographic key.

17. The computer readable storage medium of claim 16, wherein the instructions further direct the computing system to: provide the redundant data to the POS system.

18. The computer readable storage medium of claim 15, wherein the biometric data is a fingerprint image, and wherein the instructions to generate the biometric cryptographic key direct the computing system to:
extract features from the fingerprint image using Minutiae Extraction;
convert the extracted features into a binary string;
convert the binary string into a gray code sequence, wherein the gray code sequence is a stable key;
generate parity symbols using Reed-Solomon code on the gray code sequence; and
apply a SHA-256 hash function to the stable key to create the biometric cryptographic key.

19. The computer readable storage medium of claim 18, wherein the instructions further direct the computing system to: provide the parity symbols to the POS system.

20. The computer readable storage medium of claim 15, wherein the instructions to generate the biometric cryptographic key comprise a symmetric-key algorithm.
